(19) United States
(12) Patent Application Publication
(10) Pub. No.: US 2008/0110695 A1
(43) Pub. Date: May 15, 2008

(54) High efficiency, frequency-tunable, acoustic wool and method of attenuating acoustic vibrations

(76) Inventor: W. Thomas Mc Clellan, Fort Lauderdale, FL (US)

Correspondence Address: LERNER GREENBERG STEMER LLP, P O BOX 2480, HOLLYWOOD, FL, 33022-2480, US

(21) Appl. No.: 11/599,745

(22) Filed: Nov. 15, 2006

(51) Int. Cl. G10K 11/16

(52) U.S. Cl. 181/296; 181/175

(57) ABSTRACT

A high-efficiency, frequency-tunable, acoustic wool, includes a multiplicity of randomly-arrayed, continuous fibers. The fibers have segments differing in at least one physical parameter for attenuating acoustic vibrations. A method of attenuating acoustic vibrations includes providing continuous fibers having segments differing in at least one physical parameter. A multiplicity of the fibers are randomly arrayed into an acoustic wool.

### BACKGROUND OF THE INVENTION

1. Field of the Invention

The invention relates to a high-efficiency, frequency-tunable, acoustic wool.

2. Description of the Related Art

Acoustic wool is a continuous fiber material of various suitable compounds, minerals or metals, spun or arrayed in a generally random, non-uniform manner and formed into useful shapes or panels for acoustic attenuation. Different compositions of mineral wool, for example, are described in many U.S. patents and publications. Mineral wool generally uses a binder to hold fibers together, whereas steel wool, for example, may be merely pressed together. Those more abundant, more moisture and heat-resistant simulations of the original sheep's wool, continue those same unique properties of interrupting the acoustic energy with flexible, random-angled, random-length fibers which interrupt, reflect, refract, disperse, phase-shift and absorb the acoustic waves by oscillation of the fibers and conversion by such “work” to heat energy. Efficacy is also accomplished due to its ragged surface, which yields minimal surface reflection back toward the sound source or re-radiation through the material in a direction away form the source. The effectiveness of random fiber or acoustic wool material is generally proportional to its fiber weight to volume ratio or density. Increasing the material's density increases acoustic efficacy within certain limits, but increasing density also imparts the negatives of increased expense, increased weight and surface reflectivity. More importantly, those negative effects increase at a greater rate relative to the increase in acoustic attenuation in a reversal of diminishing return.

The most common method of increasing fiber to volume density is to increase fiber weight, its diameter, or simply crowding more fiber per volume. Although somewhat effective, that approach narrows the frequency range of attenuated sound and more rapidly accentuates the negatives of cost and weight. Maintaining small fiber diameter and flexibility is critical to continuing the suspended particle mobility necessary to preserve the mass oscillations over a broad frequency range and improved attenuation through absorption.

### SUMMARY OF THE INVENTION

It is accordingly an object of the invention to provide a high-efficiency, frequency-tunable, acoustic wool and a method of attenuating acoustic vibrations, which overcome the hereinafore-mentioned disadvantages of the heretofore-known devices and methods of this general type and which improve acoustic attenuation by markedly improving the “mass effect” dampening of acoustic wool materials without increasing reflectivity or significantly elevating the negatives of cost and weight as in the prior art.

With the foregoing and other objects in view there is provided, in accordance with the invention, a high-efficiency, frequency-tunable, acoustic wool. The acoustic wool comprises a multiplicity of randomly-arrayed, continuous fibers. The fibers have segments differing in at least one physical parameter for attenuating acoustic vibrations. This is accomplished by causing the acoustic wave traveling in a preferred straight line to be broken, disrupted, dispersed, phase-shifted, refracted, reflected, scattered and attenuated by thousands of separate interactions.

In accordance with another feature of the invention, the at least one physical parameter is weight, length, diameter, shape, mutual spacing or geometry. The shape may be cylindrical, fusiform, faceted, spherical, flat-round or rectangular. These parameters assist in dissipating and attenuating the acoustic wave.

In accordance with a further feature of the invention, the segments are fused, adhered or formed in the fibers. These features provide an acoustic wool which is able to be used for many applications.

In accordance with an added feature of the invention, the segments of each of the fibers have different physical parameters or the segments of one of the fibers have different physical parameters. The physical parameters are varied according to need.

In accordance with an additional feature of the invention, the acoustic wool has a linear or shaped outer surface within which the fibers are disposed. The outer surface may be formed as required in dependence on the application for which the acoustic wool is to be used.

In accordance with yet another feature of the invention, the segments have a regular or irregular shape, an even or uneven spacing, an equal or unequal length or an equal or unequal weight. All of these parameters are useful in providing the widest possible range of wave attenuations.

With the objects of the invention in view, there is also provided a method of attenuating acoustic vibrations. The method comprises providing continuous fibers and randomly arraying a multiplicity of the fibers into an acoustic wool.

In accordance with a concomitant mode of the invention, a frequency of the acoustic wool is tuned by varying the physical parameters. The many physical parameters mentioned above provide endless tuning possibilities.

The fiber-to-volume density can be dramatically improved while maintaining excellent fiber flexibility and improving the desirable mass mobility, by coupling the small diameter fiber to the “localized” areas or particles of increased mass, according to the invention.

It is important for these masses to be highly mobile in order to “react to” and therefore “interfere with” the acoustic wave. The small fiber diameter between the relatively heavy masses creates a “weight suspended on springs” effect. The masses become hyper-mobile while remaining unevenly and non-harmonically suspended. These thousands of independent weight particles are free to move in all three axes (x, y and z), to efficiently react to and “couple with” these unwanted sound waves, at any angle of incidence, and to absorb energy over a much broader acoustic frequency range.

The prior art use of one or more solid decoupling barriers is common but they are of very limited effectiveness and are troubled with significant weight penalties and acoustic reflection and re-radiation tendencies. They are notorious for responding only to a narrow range of frequencies and then only at significant amplitudes of loudness and high angles of incidence. The solid decoupling layers must always be supported on both sides by layers of foam or other materials which further impair their ability to respond to wide frequency ranges. Low incidence angle waves and low amplitude acoustic energy have near zero interaction with solid decoupling layers and are reflected virtually unchanged.

Breaking up those ineffective, solid, uniform, surfaces into thousands of separated, individual, irregularly-shaped, unevenly-weighted particles which are unevenly suspended by the continuous fiber, creates a superior acoustic barrier. These separate weights or masses suspended on the continuous fiber act together as a sum greater than the separate parts to create a deep forest of obstructions which is impossible for the uniformly-structured sound waves, traveling in straight lines, to pass through without being significantly altered.

Some of the prior art uses individual particles of heavy vinyl or lead imbedded in layers of foam, but also with limited effectiveness. The ratio of the “mass of the embedded particles” to the “mass of the supporting foam” is so similar that the particles show little flexibility of movement. They have insignificant response to sound vibrations and virtually no acoustic coupling. The fact that they are surrounded by relatively stiff support as compared to their individual mass, restricts their acoustic effects to acoustic scatter. Foam, because of its air content and soft structure, is one of the poorest sound attenuators.

Upon “coupling or connecting energy” to those thousands of separate masses, the masses are induced into sympathetic oscillation with their matching frequencies and attempt to vibrate in harmony or resonance with the perceived wave. Since the particles are suspended in a dampened manner, the frequency is slowed or shifted lower in frequency. That matching sound or frequency portion of the wave is decoupled or disconnected from its parent sinusoidal wave. The symmetrical and precisely-structured sound wave, traveling in its preferred straight line, is broken, disrupted, dispersed, phase-shifted, refracted, reflected, and scattered by thousands of those separate impactions, interactions or couplings between the wave or wave fragments and the irregularly-separated, irregularly-suspended, irregularly-weighted, and irregular-surfaced masses. The acoustic wave energy is further attenuated as it is consumed by conversion to heat energy as “work” is performed by oscillating the thousands of frequency-sensitive, moveable masses.

The invention also prevents the further migration or retransmission of the acoustic wave and achieves a marked improvement in bi-directional attenuation throughout the total panel because of widespread focused densities. A virtual forest of acoustic obstructions must be passed on the way in and at reflection or scatter they must also be passed on the way out.

This improvement in the art is a new technique of adding a more specific and “effective density” to the barrier. Effective density is the focused concentration of varying weight particles susceptible to different frequency ranges for increased interaction or coupling, lighter particles for the high, medium particles for the middle, heavier particles for the lower frequencies. These acoustically sensitive particles, when interacting with the sound wave, become acoustic barriers. The focused mass center or particles are markedly heavier than the connecting suspension fibers and are unevenly distributed, unevenly suspended, and irregular surfaced, to further improve acoustic attenuation without adding ineffective weight over a broad area of the acoustic material. By focusing on the weakness of the structured sound wave, the invention provides a specific suspended particle system to couple with or be acted upon by the widest possible frequency range and amplitude level noises. When the wave couples to the particles, the energy is consumed and the wave is destroyed.

The integrity and structural completion of the “face” or surfaces of the finished acoustic material can be maintained by the use of hardening binders, resins or epoxies at the surface or near surface intersections or crossings of the fibers or by a layer of cloth-like material bonded to the surface fibers. Binders can also be used throughout the product as needed to prevent separation if the normal inter-meshing of the random arraying is insufficient for product integrity.

Other features which are considered as characteristic for the invention are set forth in the appended claims.

Although the invention is illustrated and described herein as embodied in a high-efficiency, frequency-tunable, acoustic wool and a method of attenuating acoustic vibrations, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1A is a diagrammatic, side-elevational view of a prior art continuous acoustic wool fiber of constant diameter;

FIG. 1B is a longitudinal-sectional view of a prior art acoustic wool with randomly-arrayed, continuous fibers of constant diameter;

FIG. 2A is a side-elevational view of a continuous fiber according to the invention, having variable weight, length and spaced segments of cylindrical shapes;

FIG. 2B is a side-elevational view of a continuous fiber according to the invention, having variable weight, length and spaced segments of fusiform shapes;

FIG. 2C is a side-elevational view of a continuous fiber according to the invention, having variable weight, length and spaced segments of irregularly faceted surfaces;

FIG. 2D is a side-elevational view of a continuous fiber according to the invention, having variable weight, length and spaced segments of spherical or two-dimensional round-flat forms;

FIG. 2E is a side-elevational view of a continuous fiber according to the invention, having added similar or dissimilar material elements of variable weight, length, spacing and geometry, by fusion or adherence;

FIG. 2F is a longitudinal-sectional view of an acoustic wool according to the invention, with randomly-arrayed, continuous fibers of variable diameter, shape and spacing, illustrating the more effective widespread increase in focused density fiber.

### DESCRIPTION OF THE PREFERRED EMBODIMENTS

Reference will now be made to the figures of the drawings in detail, in which the illustrations are not to scale but demonstrate the variations of shape, size, weight and spacing, noting that the subtle differences therebetween would be difficult to visualize at the small scale and sizes sensitive to the targeted frequencies.

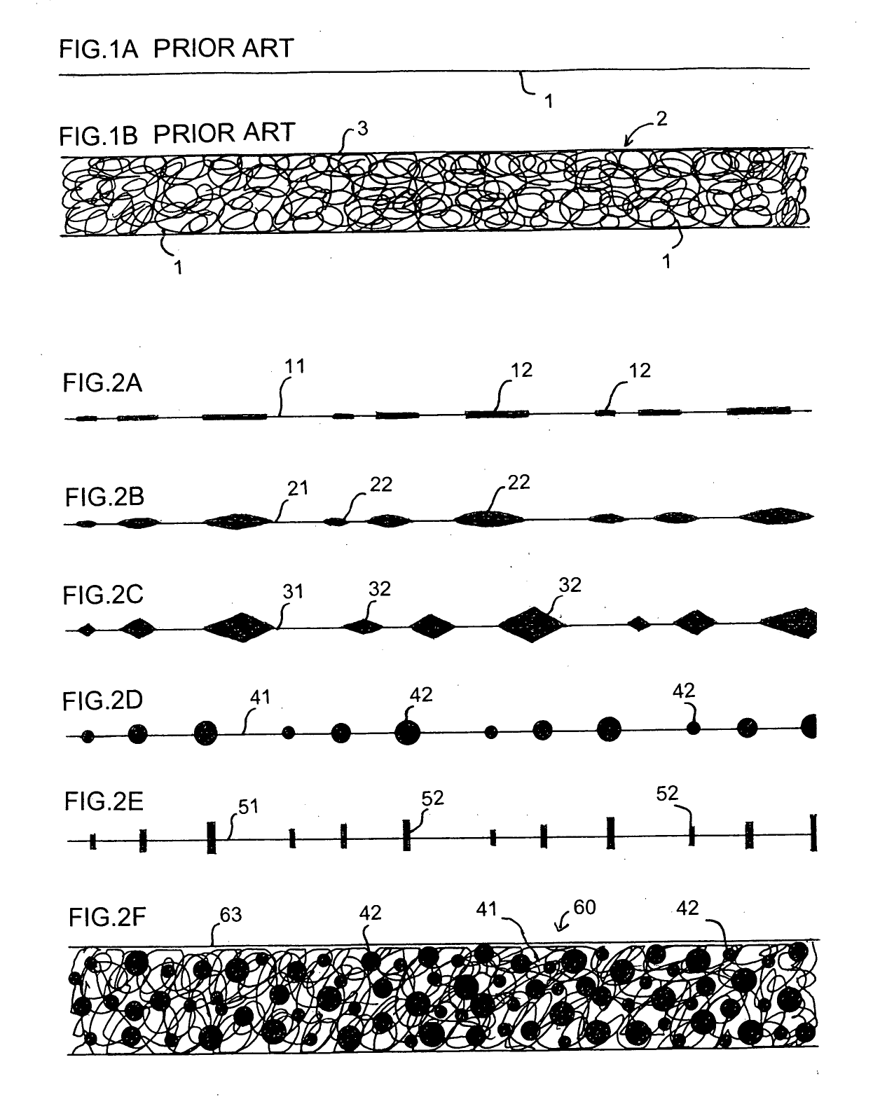

Referring now, in particular, to FIG. 1A, there is seen a side-elevational view of a continuous acoustic wool fiber 1 according to the prior art, which has a constant diameter indicated by a straight line. The longitudinal-sectional view of FIG. 2B illustrates an acoustic wool 2 according to the prior art, having a random array of the continuous fibers 1 of constant diameter seen in FIG. 1A, within an outer surface or shell 3. The outer surface or shell 3 is generally formed by pressing, such with rollers. A binder may be added for mineral wool, whereas steel wool will retain its shape by pressing alone.

FIG. 2A is a side-elevational view of a continuous fiber 11 according to the invention. The fiber 11 has masses, particles, segments or elements 12 of cylindrical shapes. The cylindrical segments 12 have variable weight, length and spacings.

Another continuous fiber 21 according to the invention is shown in FIG. 2B. The fiber 21 has masses, particles, segments or elements 22 of fusiform shapes which are variable in weight, length and spacing.

A continuous fiber 31 according to the invention depicted in FIG. 2C has masses, particles, segments or elements 32 with irregularly faceted surfaces. The irregular segments 32 have variable weight, length and spacings.

FIG. 2D shows a continuous fiber 41 according to the invention, in which masses, particles, segments or elements 42 of spherical or two-dimensional round-flat forms are provided. The spherical or round-flat segments 42 have variable weight, length and spacings.

A further continuous fiber 51 according to the invention is shown in FIG. 2E. The fiber 51 has masses, particles, segments or elements 52 which may be rectangular and are added by fusion or adherence. The segments 52 may be formed of materials which are similar to or dissimilar from each other. The segments 52 have variable weight, length, spacing and geometry, as shown.

It can be seen from the longitudinal-sectional view of FIG. 2F that an acoustic wool 60 has continuous fibers, which may be formed of minerals, metals such as steel, or other suitable compounds. The fibers are randomly arrayed within an outer surface or shell 63 formed by pressing, such as by rollers. Mineral fibers may use a binder, whereas steel fibers generally do not require a binder. The outer surface or shell 63 may be linear, straight, planar, flat or unbroken as shown or it may be shaped according to the particular application for which it is intended.

The integrity and structural finish of the outer surface or shell 63 of the completed acoustic material can be maintained by using hardening binders, resins or epoxies at the surface or near surface intersections or crossings of the fibers, or the shell 63 may be a layer of cloth-like material bonded to the surface fibers. If normal inter-meshing caused by random arraying is insufficient for integrity of the final product, binders can also be used throughout the product as needed to prevent separation.

Although only the fibers 41 of FIG. 2D having the spherical or two-dimensional round-flat form segments 42 are shown in the acoustic wool 60 according to the invention, it is understood that any of the fibers 11, 21, 31, 41, 51 can be used, that any combination of those fibers can be used and that the parameters may be varied within a fiber as well. The randomly arrayed continuous fibers having variable diameter, shape and spacing, provide the acoustic wool 60 with a more-effective, widespread increase in focused density of the fiber.

The weight, length, diameter, shape, mutual spacings and geometries of the masses, particles, segments or elements 12, 22, 32, 42, 52 of the fibers 11, 21, 31, 41, 51 may be collectively referred to herein as physical parameters which differ from one another. The physical parameters are varied for tuning a frequency of the acoustic wool, according to the intended application for which it is to be used.

1. A high-efficiency, frequency-tunable, acoustic wool, comprising:
a multiplicity of randomly-arrayed, continuous fibers;
said fibers having segments differing in at least one physical parameter for attenuating acoustic vibrations.

2. The acoustic wool according to claim 1, wherein said at least one physical parameter is selected from the group consisting of weight, length, diameter, shape, mutual spacing and geometry.

3. The acoustic wool according to claim 1, wherein said at least one physical parameter is a shape selected from the group consisting of cylindrical, fusiform, faceted, spherical, flat-round and rectangular.

4. The acoustic wool according to claim 1, wherein said segments are fused to said fibers.

5. The acoustic wool according to claim 1, wherein said segments adhere to said fibers.

6. The acoustic wool according to claim 1, wherein said segments are formed in said fibers.

7. The acoustic wool according to claim 1, wherein said segments of each of said fibers have different physical parameters.

8. The acoustic wool according to claim 1, wherein said segments of one of said fibers have different physical parameters.

9. The acoustic wool according to claim 1, which further comprises a linear outer surface within which said fibers are disposed.

10. The acoustic wool according to claim 1, which further comprises a shaped outer surface within which said fibers are disposed.

11. The acoustic wool according to claim 1, wherein said segments have a regular or irregular shape.

12. The acoustic wool according to claim 1, wherein said segments have an even or uneven spacing.

13. The acoustic wool according to claim 1, wherein said segments have an equal or unequal length.

14. The acoustic wool according to claim 1, wherein said segments have an equal or unequal weight.

15. The acoustic wool according to claim 1, wherein said fibers are selected from the group consisting of mineral fibers and metal fibers.

16. The acoustic wool according to claim 1, wherein said fibers are steel fibers.

17. The acoustic wool according to claim 1, which further comprises a surface within which said fibers are disposed, and hardening binders, resins or epoxies disposed at said surface or near surface intersections or crossings of said fibers.

18. The acoustic wool according to claim 1, which further comprises a surface within which said fibers are disposed, and a shell of cloth-like material bonded to said fibers at said surface.

19. A method of attenuating acoustic vibrations, the method comprising the following steps: providing continuous fibers having segments differing in at least one physical parameter; and
randomly arraying a multiplicity of the fibers into an acoustic wool.

20. The method according to claim 19, which further comprises tuning a frequency of the acoustic wool by varying the physical parameters.

21. The method according to claim 19, which further comprises selecting the at least one physical parameter from the group consisting of weight, length, diameter, shape, mutual spacing and geometry.

22. The method according to claim 19, which further comprises selecting the at least one physical parameter from a group of shapes consisting of cylindrical, fusiform, faceted, spherical, flat-round and rectangular.

23. The method according to claim 19, which further comprises fusing, forming or adhering the segments together.

24. The method according to claim 19, which further comprises providing the segments with a regular or irregular shape, an even or uneven spacing, an equal or unequal length or an equal or unequal weight.

25. The method according to claim 19, which further comprises selecting the fibers from the group consisting of mineral fibers and metal fibers.

26. The method according to claim 19, wherein the fibers are steel fibers.

27. The method according to claim 19, which further comprises pressing the fibers to form an outer surface of the acoustic wool.

28. The method according to claim 19, which further comprises providing a surface within which the fibers are disposed, and adding hardening binders, resins or epoxies at the surface or near surface intersections or crossings of the fibers.

29. The method according to claim 19, which further comprises providing a surface within which the fibers are disposed, and adding a shell of cloth-like material bonded to the fibers at the surface.

30. The acoustic wool according to claim 1, wherein said segments are individually separated along said fibers.

31. The method according to claim 19, which further comprises separating individual segments from one another along the fibers.
